(19) United States
(12) Patent Application Publication
(10) Pub. No.: US 2003/0033548 A1
(43) Pub. Date: Feb. 13, 2003

(54) Uninterruptible power supply management network system

(76) Inventors: Christian L. Kuiawa, Warwick, RI (US); David A. Cardimino JR., Warwick, RI (US); Todd J. Giaquinto, Cranston, RI (US); Thomas F. Wenisch, Narragansett, RI (US)

Correspondence Address: MINTZ, LEVIN, COHN, FERRIS, GLOVSKY, AND POPEO, P.C., ONE FINANCIAL CENTER, BOSTON, MA, 02111, US

(21) Appl. No.: 09/924,050

(22) Filed: Aug. 7, 2001

(51) Int. Cl. G06F 1/26; G06F 1/28; G06F 1/30

(52) U.S. Cl. 713/300

(57) ABSTRACT

Aspects of the invention are directed to configuring multiple uninterruptible power supply (UPS) devices coupled to a network. According to one aspect of the invention, multiple agents are coupled between the network and the multiple UPS devices to be managed, each agent being associated with a UPS device. A server stores an agent list containing the list of agents and configuration profiles having configuration settings that are used to configure the UPS devices. The server establishes communication with the agents of UPS devices that require configuration. The server transmits configuration setting of the configuration profile applicable to the UPS device, wherein the agent configures the UPS device using the transmitted configuration setting.

### BACKGROUND OF THE INVENTION

1. Field of the Invention

The present invention relates to methods and apparatus for managing multiple uninterruptible power supply (UPS) devices and in particular, to methods and apparatus for managing multiple UPS devices in a network system.

2. Background of the Invention

Uninterruptible power supply (UPS) devices are widely used to protect telecommunication systems, data and computing systems and other electrical systems from power failure where loss of data or signals can have a detrimental impact to the operation of the system. Generally, a UPS device contains a charging circuit that is powered by an AC power source and a rechargeable battery that is continuously charged by the charging circuit during operation. The system that is protected by the UPS device is either powered by the battery or the AC power source via the UPS device. If power failure does occur and the AC power source is interrupted during operation, the battery continues to power the system until the AC power source is able to resume supplying power, which then replenishes the battery's energy. In other instances, such as in a computer system, for example, the battery of the UPS device stores a charge that is just sufficient to operate the system until the system is able to back up its data in a volatile memory (such as random access memory) to a more stable non-volatile memory (such as a disk drive), thereby ensuring that no data is lost.

There are many instances in which an operation is performed by multiple systems and individual systems require their own UPS device. For example, an Internet service provider may use multiple servers to provide its Internet service. These servers provide for the interchange of information for numerous clients that have access to the servers. Typically, the servers are in a single location or they are dispersed in various locations. Some UPS devices are programmable to suit the operating environment of each server. The UPS devices can be programmed at the server site or they can be coupled to a network and be programmed via network communication. However, according to a known method, each UPS device that is coupled to the network is programmed on a one-to-one basis, that is, UPS device settings are individually applied for each UPS device configured. Typically, a user manually applies or modifies via network communication each UPS device individually and separately. This task can be mundane and time consuming, particularly if there are numerous UPS devices and/or the network is experiencing heavy traffic.

### SUMMARY OF THE INVENTION

According to one aspect of the invention, a method of configuring a plurality of uninterruptible power supply (UPS) devices coupled to a network comprises storing a plurality of configuration profiles having configuration settings to configure the UPS devices, storing a list of UPS devices to be managed, selecting at least a portion of the plurality of UPS devices from the list of UPS devices, and for each selected UPS device, establishing communication with the UPS device, selecting a configuration profile from the plurality of configuration profiles to configure the UPS device and transmitting configuration setting of the configuration profile to the UPS device.

The method can include one or more of the following features: establishing communication with an agent of the UPS device and transmitting configuration settings to the agent of the UPS device; retrieving identification information of the UPS device, retrieving a system protection strategy of the UPS device and selecting the configuration profile applicable to the UPS device based on the identification information and the system protection strategy; retrieving a firmware version of the UPS device, associating the UPS device with a family and selecting the configuration profile applicable to the UPS device based on the family and the system protection strategy; detecting an additional UPS device to be configured that is added to the list of UPS devices, selecting the configuration profile applicable to the added UPS device and transmitting configuration setting of the configuration profile to the added UPS device; storing a second list of UPS devices to be configured, associating a second configuration profile with the second list of UPS devices, receiving re-configured settings for the second configuration profile and re-configuring the plurality of UPS devices associated with the second list of UPS devices using the re-configured settings of the second configuration profile.

In another aspect of the invention, a computer for configuring a plurality of uninterruptible power supply (UPS) devices coupled to a network comprises a plurality of configuration profiles stored in a memory, the configuration profiles having configuraton settings to configure the UPS devices, a list of UPS devices to be managed stored in the memory and the computer is configured to select at least a portion of the plurality of UPS devices in the list of UPS devices and for each selected UPS device, the computer is configured to establish communication with the UPS device, select a configuration file from the plurality of configuration profiles to configure the UPS device and transmit the configuration settings of the configuration profile to the UPS device.

The computer can include one or more of the following features: the computer is configured to establish communication with an agent of the UPS device and transmit the configuration settings to the agent of the UPS device; a system protection strategy stored in the memory and the computer is configured to retrieve an identification information stored in the UPS device and to retrieve the system protection strategy from the memory, wherein the computer is further configured to select the configuration profile applicable to the UPS device based on the identification information and the system protection strategy and transmit the configuration settings of the applicable configuration profile to the UPS device; the identification information stored in the UPS device is a firmware version of the UPS device; the computer is configured to detect an additional UPS device to be configured that is added to the list of UPS devices, select the configuration profile applicable to the added UPS device and transmit the configuration setting of the applicable configuration profile to the added UPS device; a second list of UPS devices stored in the memory, a second configuration profile stored in the memory and associated with the second list of UPS devices and the computer is configured to receive a re-configured settings for the second configuration profile and the computer is configured to reconfigure the plurality of UPS devices associated with the second list of UPS devices using the re-configured settings of the second configuration profile.

Other aspects and advantages of the invention will become apparent in the detailed description to follow.

### BRIEF DESCRIPTION OF THE DRAWINGS

For better understanding of the invention, reference is made to the drawings which are incorporated herein by reference and in which:

FIG. 1 is a schematic diagram of an uninterruptible power supply (UPS) management network system including a console, a management server and plurality of agents, each agent coupled to a UPS device in accordance with an embodiment of the invention;

FIG. 2 is a schematic diagram of a management server having an agent list and configuration profiles in accordance with an embodiment of the invention;

FIG. 3 is a flow process of the UPS management network system in accordance with an embodiment of the invention; and

FIG. 4 is a schematic diagram of a management server having multiple agent lists and associated configuration profiles in accordance with the invention.

### DETAILED DESCRIPTION OF THE INVENTION

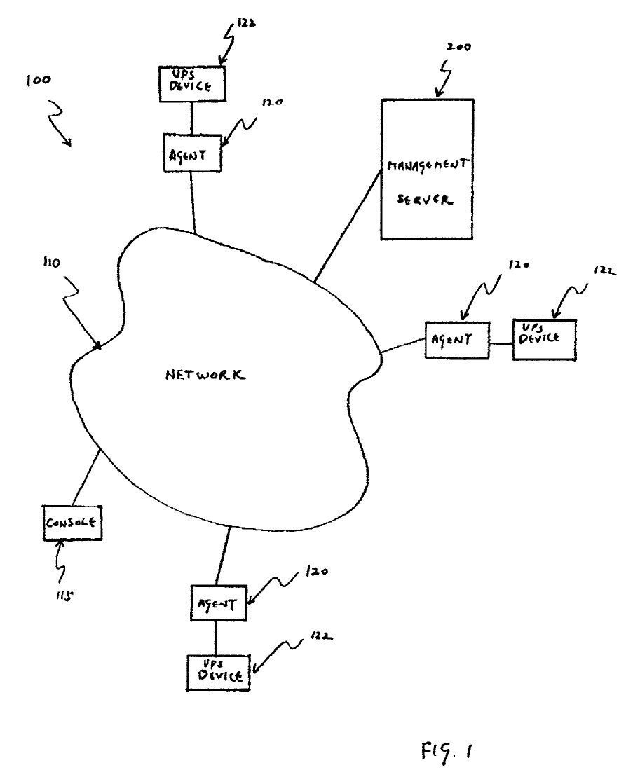

One embodiment of the invention will now be described with reference to FIG. 1 which illustrates an uninterruptible power suppy (UPS) management network system 100 comprising a network 110, a console 115, a management server 200 and a plurality of agents 120, each agent 120 being associated with a UPS device 122, and wherein the UPS device 122 protects an electrical system.

In one embodiment of the invention, the agent 120 can be a circuit contained within the UPS device 122 that is configured to receive/transmit instructions and/or data bi-directionally between the management server 200 and the UPS device 122. In another embodiment, the agent 120 can be a software module that is installed in the management server 200 and is in bi-directional communication with the UPS device 122. In still another embodiment, the agent may be a software and/or hardware module contained within a computer that receives electrical power from the UPS device 122. It should be noted that the agents described above are examples and other forms of agents are within the knowledge of one skilled in the art.

The electrical system can be a telecommunication system, a data processing system, a computing system or one of a number of other systems. The network 110 can be a local area network (LAN), a wide area network (WAN) or the Internet. The network 110 provides a communication link which is bi-directional between the console 115 and the management server 200 and between the management server 200 and the plurality of agents 120 (in instances where the agents 120 are external to the management server 200 and coupled together via the network 110). In the context of the Internet, identification between the console 115, the management server 200 and the plurality of agents 120 can be achieved by using well known Internet Protocol (IP) techniques. Data transfer between the management server 200 and an agent 120 can be achieved by using well known Transport Control Protocol (TCP)/IP sockets with data being serial Java objects. Data communication between the agent 120 and the UPS device 122 can be serial communication such as RS-232 or Universal Serial Bus (USB) or parallel communication. However, other well known data formats and protocols can be used such as, for example, the Simple Network Management Protocol (SNMP).

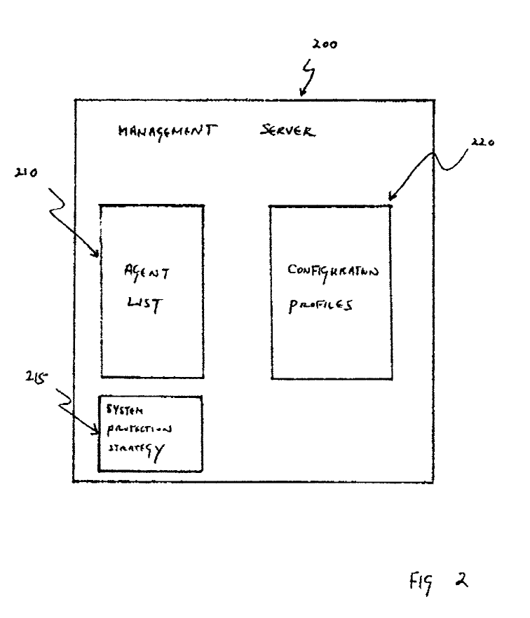

The management server will now be described in further detail with reference to FIG. 2. The management server 200 is configured to store in a memory an agent list 210 comprising a list of agents 120, a system protection strategy 215, which will be described further below and configuration profiles 220 having configuration settings that are used to configure the UPS devices 122. A memory can include volatile memories such as random access memory (RAM) and the like or non-volatile memories such as Flash memory, magnetic or optical disk drives and the like. The agent list 210, the system protection strategy 215 and configuration profiles 220 can be pre-installed in the management server 200 during server initialization or they can be installed in the server 200 during operation by using the console 115. By utilizing the stored agent list 210, the system protection strategy 215 and the configuration profiles 220, the management server 200 functions as a centralized management system that configures the settings of each of the UPS devices 122 to be managed via the agents 120. In one embodiment, several management servers are involved in managing the UPS devices and each UPS device is managed by only one management server. One advantage of this arrangement is that it prevents the UPS devices from receiving conflicting configuration settings from different management servers and further provides for better management of each UPS device.

A configuration profile is typically applied to a UPS device 122 when the UPS device 122 is added to the network system or in another instance, when the configuration profile 220 is re-configured for the UPS device 122. According to one embodiment, an agent list 210 contains a list of IP addresses for each agent 120. By utilizing the IP address, the management server 200 establishes communication with the agent 120, for example, by using TCP/IP protocol. After a communication link has been established, the management server 200 requests via the agent 120 the identification information of the UPS device 122.

Identification of the UPS device 122 can be performed by the management server 200 when it receives the identification information transmitted by the UPS device 122. In one embodiment, the identification information can be an information packet that informs the management server 200 what configuration parameters are available at the UPS device 122 from which the management server 200 deduces the family of the UPS device 122. In other embodiments, the identification information can be a firmware version information of the UPS device 122 from which the management server 200 also deduces the family of the UPS device 122. In one embodiment, the management server 200 can deduce the family of the UPS device 122 by utilizing a lookup table stored in a memory. According to one aspect of the invention, the UPS device 122 can be classified into a certain family based on common settings such as transfer voltages, shutdown parameters, power failure parameters and so forth. In another instance, UPS devices available from American Power Conversion based in West Kingston, R.I., have their UPS devices pre-classified into families such as Back-UPS Pro, Smart-UPS, Matrix and so forth.

Once the management server 200 determines the family of the UPS device the management server 200 retrieves the system protection strategy 215 of the UPS device 122 from the memory. The system protection strategy may be to shutdown the UPS device at the first sign of trouble that can lead to the system powered by the UPS device being damaged (Safety Setting) or it may be to run the UPS device and to shut it down if there is an imminent danger of the system being damaged (Runtime Setting). The management server 200 then selects a configuration profile based on the family of the UPS device and the system protection strategy.

The configuration profile 220 contains configuration settings that pertain to various events. Examples of events can be voltage thresholds, power failure, battery threshold, network communication status, runtime to failure, load status, temperature status, humidity status, system diagnostics, bypass initiations, shutdown procedures and so forth. A selection of the configuration profile 220 is performed by the management server 200 based on family and system protection strategy. In one embodiment of the invention, the number of configuration profiles is dependent on the number of families the management server 200 supports multipled by two (to reflect the system protection strategy, i.e. Safety Setting and Runtime Setting). Stated differently, for each family supported there are two configuration profiles that can be selected based on the system protection strategy. Thus as an example, if the family is “Back-UPS” and the system protection strategy is “Safety Setting” the management server 200 selects the appropriate configuration profile based on this information, retrieves the configuration settings from the configuration profile and transmit the configuration settings to the agent 120, which configures the UPS device 122 in accordance with the settings.

In the embodiment illustrated in FIG. 2, the management server 200 is shown to have a single agent list 210. In this configuration, a general configuration setting is applied to each UPS device being managed when its associated agent is added to the agent list 210 or when the system protection strategy is changed in which case, all UPS devices 122 associated with the agent list 210 is re-configured based on the changed system protection strategy. The term general setting is used because the system protection strategy 215 is general to all agents in the agent list 210. In addition, the applied configuration profile 220 based on the family and system protection strategy is general to the agents in the agent list 210 (as opposed to a configuration profile that is specific to a UPS device). Thus, for example, after the UPS device is classified, if Safety Setting is the stored system protection strategy, then a configuration profile matching the classification and system protection strategy is applied to its associated agent 120.

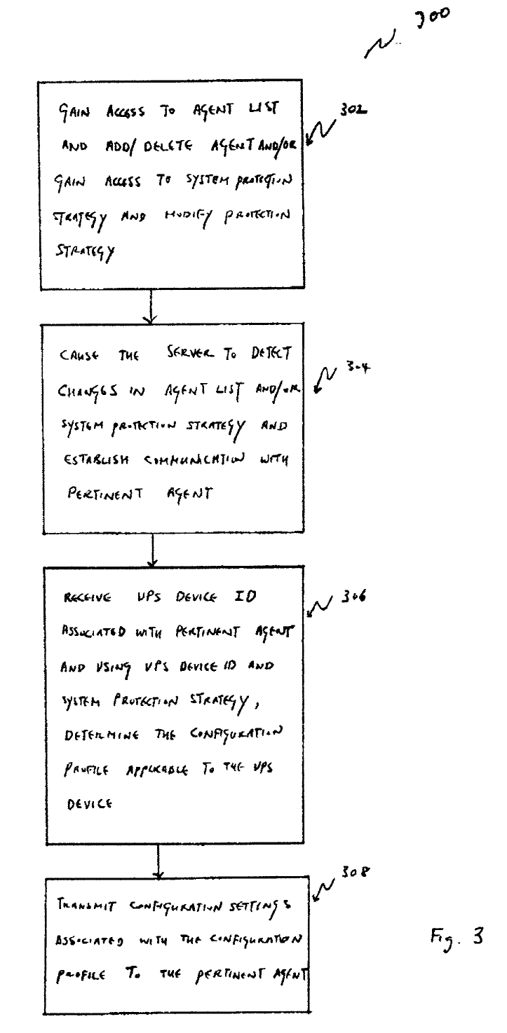

In conjunction with FIG. 3, an exemplary process 300 for applying the general configuration settings to the UPS devices by the management server 200 system will now be described. In block 302 of the process 300, a user uses the console 115 to gain access to the agent listing 210 of the management server 200. The console 115 can be a personal computer that is coupled to the network 110. In the case of the Internet, the computer uses a conventional browser to communicate with the management server 200. Once the user is in communication with the management server 200 the user can add or delete an agent from the agent listing 210. In block 304, the management server 200 detects a change in the agent list 210 and looks up its agent list 210. If an agent 120 has been added to the agent list 210, the management server 200 retrieves the IP address of the added agent 120 from the agent list 210. Using the IP address, the management server 200 establishes communicaton with the agent 120 via the TCP/IP protocol. Usually, the agent 120 is in active mode and responds to network-based requests from the management server 200 to configure the UPS device 122. Once a communication has been established, in block 306, the management server 200 requests for identification information of the UPS device 122 via the agent 120. It should be noted that in blocks 302-304, the user could change the system protection strategy in which case the server will access the IP addresses of all the agents 120 listed in the agent list 210 to modify the configuration settings of the UPS devices 122 associated with those agents 120.

In block 306, when the management server 200 receives the identification information, the management server 200 determines which family the UPS device 122 belongs to. The management server then retrieves the system protection strategy from the memory. If the system protection strategy is a Safety Setting, the management server 200 retrieves a configuration profile 220 corresponding to the family and the Safety Setting and transmits the configuration settings to the agent 120 which then configures the UPS device 122 (block 308). On the other hand, if the system protection strategy is a Runtime Setting, the management server 200 retrieves a configuration profile 220 corresponding to the family and Runtime Setting to configure the UPS device 122.

When the appropriate profile 220 has been found, the management server 200 goes over each setting, which is transmitted to the agent 120. In the case where a Runtime Setting profile has been chosen, the UPS device 122 will not shut off until there is the least amount of runtime left to allow for a safe shutdown. The Safety Setting profile, on the other hand, will shut down the UPS device 122 when one or more indications of trouble occurs.

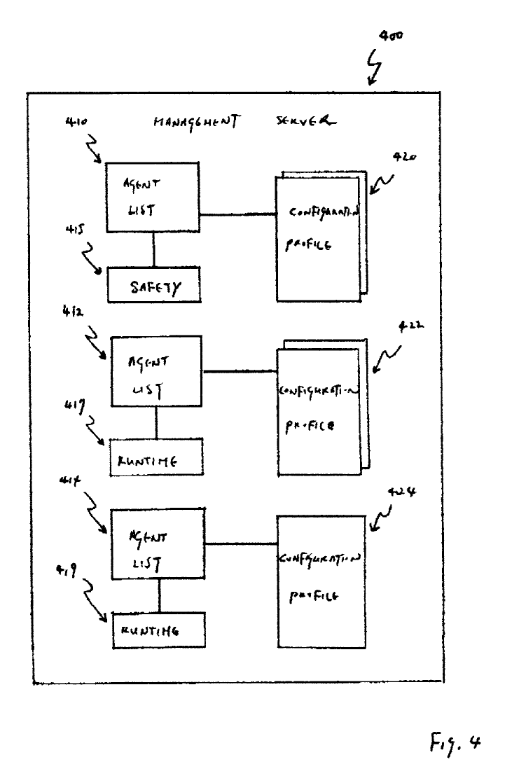

FIG. 4 illustrates an alternative embodiment of a management server 400 with multiple agent lists 410, 412, 414 each agent list 410, 412, 414 being associated with one or more configuration profiles 420, 422, 424 and system protection strategies 415, 417, 419. In this configuration, the UPS management server 400 allows the user to configure certain configuration profiles that implement the user's specific settings for certain UPS devices. As an example, the agents associated with the agent list 410, 412 can have configuration profiles 420, 422 that configure the UPS devices based on family and system protection strategy as in the general configuration settings of the UPS device described above. In the illustrated embodiment, the system protection strategy 415 for agent list 410 is Safety Setting and the system protection strategy 417 for agent list 412 is Runtime Setting. On the other hand, the agents associated with the agent list 414 have a configuration file 424 that is tailored to the user's specific configuration settings. In this instance, the user uses a console 115 (see FIG. 1) to access the configuration profile 424 at the server 400 and re-configure the configuration settings of the configuration file 424. The management server 400, detecting a change in the configuration profile 424, retrieves the IP addresses of the agents of the agent list 414 corresponding to the configuration profile 424 and transmits the configuration settings to those agents for re-configuration of the UPS devices. In this manner, a user can group one or more agents together to which configuration settings from a configuration profile can be sent that is specific to those UPS devices.

Many advantages and benefits may be obtained by the illustrative embodiments described above. One advantage is that the user can provide a list of UPS devices which require configuration and the management server automatically configures the UPS devices. Another advantage is that the user need not be familiar with all the operation parameters of the UPS devices, instead the user determines if the system protection strategy is Safety setting or Runtime setting. The server will then automaticaly select the appropriate profile based on the system protection strategy and UPS device identification information. Other advantages will be apparent to those skilled in the art.

In embodiments described above, the configuration profiles are stored in the agent and the management server notifies the agent as to which configuration profile is to be used. In other embodiments, the agents can be stored in the management server. In embodiments described above, the management server can request the agent for various data pertaining to the UPS device such as load, temperature, operating features and so forth, which on receipt, the management server transmits configuration settings from a configuration profile that is appropriate to the data received by the management server. In embodiments described above, the device to be configured can be a device other than a UPS device. For instance, the device can be a environmental monitor device that provides information concerning temperature and humidity, or the device can be a environmental conditioning device that can be configured to control temperature and humidity within its vicinity.

Having thus described at least one illustrative embodiment of the invention, various alterations, modifications and improvements are intended to be within the scope and spirit of the invention. Accordingly, the foregoing description is by way of example only and is not intended as limiting. The invention's limit is defined only in the following claims and the equivalents thereto.

What is claimed is:

1. A method of configuring a plurality of uninterruptible power supply (UPS) devices coupled to a network, the method comprising:
storing a plurality of configuration profiles, the configuration profiles having configuration settings to configure the UPS devices;
storing a list of UPS devices to be managed;
selecting at least a portion of the plurality of UPS devices from the list of UPS devices, and for each selected UPS device,
establishing communication with the UPS device;
selecting a configuration profile from the plurality of configuration profiles to configure the UPS device; and
transmitting configuration setting of the configuration profile to the UPS device.

2. The method as in claim 1, wherein establishing communication with the UPS device further comprises:
establishing communication with an agent of the UPS device; and
transmitting configuration settings to the agent of the UPS device.

3. The method as in claim 1, wherein selecting a configuration profile further comprises:
retrieving identification information of the UPS device;
retrieving a system protection strategy of the UPS device; and
selecting the configuration profile applicable to the UPS device based on the identification information and the system protection strategy.

4. The method as in claim 3, wherein retrieving of the identification information of the UPS device further comprises:
retrieving a firmware version of the UPS device;
associating the UPS device with a family; and
selecting the configuration profile applicable to the UPS device based on the family and the system protection strategy.

5. The method as in claim 1, further comprising:
detecting an additional UPS device to be configured that is added to the list of UPS devices;
selecting the configuration profile applicable to the added UPS device; and
transmitting configuration setting of the configuration profile to the added UPS device.

6. The method as in claim 1, further comprising:
storing a second list of UPS devices to be configured;
associating a second configuration profile with the second list of UPS devices;
receiving re-configured settings for the second configuration profile; and
re-configuring the plurality of UPS devices associated with the second list of UPS devices using the re-configured settings of the second configuration profile.

7. A computer for configuring a plurality of uninterruptible power supply (UPS) devices coupled to a network, the computer comprising:
a plurality of configuration profiles stored in a memory, the configuration profiles having configuraton settings to configure the UPS devices;
a list of UPS devices to be managed stored in the memory; and
wherein the computer is configured to select at least a portion of the plurality of UPS devices in the list of UPS devices and for each selected UPS device, the computer is configured to establish communication with the UPS device, select a configuration file from the plurality of configuration profiles to configure the UPS device and transmit the configuration settings of the configuration profile to the UPS device.

8. The computer as in claim 7, wherein the computer is configured to establish communication with an agent of the UPS device and transmit the configuration settings to the agent of the UPS device.

9. The computer as in claim 7, further comprising:
a system protection strategy stored in the memory; and
wherein the computer is configured to retrieve an identification information stored in the UPS device and to retrieve the system protection strategy from the memory, wherein the computer is further configured to select the configuration profile applicable to the UPS device based on the identification information and the system protection strategy and transmit the configuration settings of the applicable configuration profile to the UPS device.

10. The computer as in claim 9, wherein the identification information stored in the UPS device is a firmware version of the UPS device.

11. The computer as in claim 7, wherein the computer is configured to detect an additional UPS device to be configured that is added to the list of UPS devices, select the configuration profile applicable to the added UPS device and transmit the configuration setting of the applicable configuration profile to the added UPS device.

12. The computer as in claim 7, further comprising:
a second list of UPS devices stored in the memory;
a second configuration profile stored in the memory and associated with the second list of UPS devices; and
wherein the computer is configured to receive a re-configured settings for the second configuration profile and the computer is configured to re-configure the plurality of UPS devices associated with the second list of UPS devices using the re-configured settings of the second configuration profile.

13. An apparatus for configuring a plurality of uninterruptible power supply (UPS) devices coupled to a network, the apparatus comprising:
a memory for storing a plurality of configuration profiles, the configuration profiles having configuration settings to configure the UPS devices and the memory further storing a list of UPS devices to be managed; and
means for configuring at least a portion of the plurality of UPS devices from the list of UPS devices using at least one of the configuration profiles.

14. The apparatus as in claim 13, further comprising:
means for communicating with the UPS device.

15. The apparatus as in claim 13, further comprising:
means for receiving identification information of the UPS device; and
means for selecting the configuration profile applicable to the UPS device based on the identification information.

16. The apparatus as in claim 15, further comprising:
means for receiving a system protection strategy; and
means for selecting the configuration profile applicable to the UPS device based on the identification information and system protection strategy.

17. The apparatus as in claim 13, further comprising:
means for detecting an additional UPS device added to the list of UPS devices; and
means for selecting the configuration profile applicable to the added UPS device.

18. The apparatus as in claim 13, further comprising:
the memory to further store a second list of UPS devices to be configured;
means for associating a second configuration profile with the second list of UPS devices; and
means for receiving re-configured settings for the second configuration profile; and
means for re-configuring the plurality of UPS devices associated with the second list of UPS devices using the re-configured settings of the second configuration profile.
